(19) United States
(12) Patent Application Publication
(10) Pub. No.: US 2021/0060847 A1
(43) Pub. Date: Mar. 4, 2021

(54) DEVICE FOR PREPARING LINER

(71) Applicant: Picote Solutions Oy Ltd., FI-06450 Porvoo (FI)

(72) Inventor: Mika Lokkinen, Tallinn (EE)

(21) Appl. No.: 17/003,863

(22) Filed: Aug. 26, 2020

(30) Foreign Application Priority Data
Aug. 28, 2019 (FI) 20195708

(51) Int. Cl. B29C 63/00

(52) U.S. Cl. CPC B29C 63/0004; B29L 2023/22

(57) ABSTRACT

A device for preparing a liner to be installed in a pipe. the device comprising a top part having rollers extending between top sides and having a top belt arranged on rollers. The device further comprises a bottom part having rollers extending between bottom sides and having a bottom belt arranged on the bottom rollers. One of the bottom rollers is a pulley roller driving the bottom belt when rotated. At least one roller of the top rollers is movably attached to the top sides, and at least one roller of the bottom rollers is movably attached to the bottom sides.

### PRIOR APPLICATION

This US utility patent application claims priority from Finnish patent application no. 20195708, filed 28 Aug. 2019.

### FIELD OF THE INVENTION

The invention relates to a device for spreading epoxy evenly inside a liner used in pipe renovations.

### PRIOR ART

The pipes in real estate properties are, increasingly more often, renovated by the so-called CIPP (Cured-in-Place Pipe) method, in which inside the pipes is installed an epoxy-saturated liner, which is slid into the pipe by the inversion method using air pressure. Before installation, the outer surface of the liner is formed by an impenetrable plastic membrane and the inner surface by an absorbent material, usually felt or fabric. Into the liner is introduced epoxy in liquid form and the liner is mangled until the epoxy has spread and soaked evenly into the inside surface of the liner, after which the liner is reeled into a CIPP lining drum. In inversion, compressed air in the CIPP lining drum causes the inside of the liner in the CIPP lining drum to invert in the pipeline as the outer surface of the liner, wherein the epoxy in the outer surface adheres to the inner surface of the pipe. Once the liner is fully inverted from the CIPP lining drum into the pipe, air pressure is maintained until the epoxy has cured and the liner forms a new pipe inside the old pipe.

A disadvantage in the arrangement are the mangles according to prior art, which are heavy and require electrical outlet to power a motor of the mangle, thus they are to be fixedly installed. Preparation of the liner must then be performed in a car or a worksite container, into which the mangle is installed.

Another prior art device for this purpose is a wooden rolling pin known from the art of baking. This solution has a usability problem since both hands are needed for operating the rolling pin. Another problem is that it results an uneven layer of epoxy, i.e. varying thickness in the prepared liner.

### BRIEF DESCRIPTION OF THE INVENTION

The object of the invention is a device, which alleviates or removes the disadvantages of mangles according to prior art.

Object of the invention is achieved with a device having a top part and a bottom part, both having rollers and a belt running on the rollers. One of the rollers of the bottom part is a pulley roller driving the belt of the bottom part when rotated. The rollers of the top part can be idle rollers. The belt is tensioned with at least one of the top rollers and at least one of the bottom rollers being movably attached to the device. Preferably the device has no motor in itself but an input shaft from which the device can be operated by rotating the input shaft with e.g. a cordless drill or a power drill.

### BRIEF DESCRIPTION OF THE DRAWINGS

The invention is now described in more detail in connection with preferred embodiments, with reference to the accompanying drawings, in which:

FIG. 1 shows a device having a top part opened according to an embodiment;

FIG. 2 is an isometric view of a device according to an embodiment;

FIG. 3 is an isometric view of the device of FIG. 2 from opposite side;

FIG. 4 shows a device according to an embodiment seen from above;

FIG. 5 is a section view of Section A-A shown in FIG. 4;

FIG. 6 is an isometric section view of a device according to an embodiment; and

FIG. 7 is an isometric section view of a device of FIG. 6 from a different angle of view.

### DETAILED DESCRIPTION OF THE INVENTION

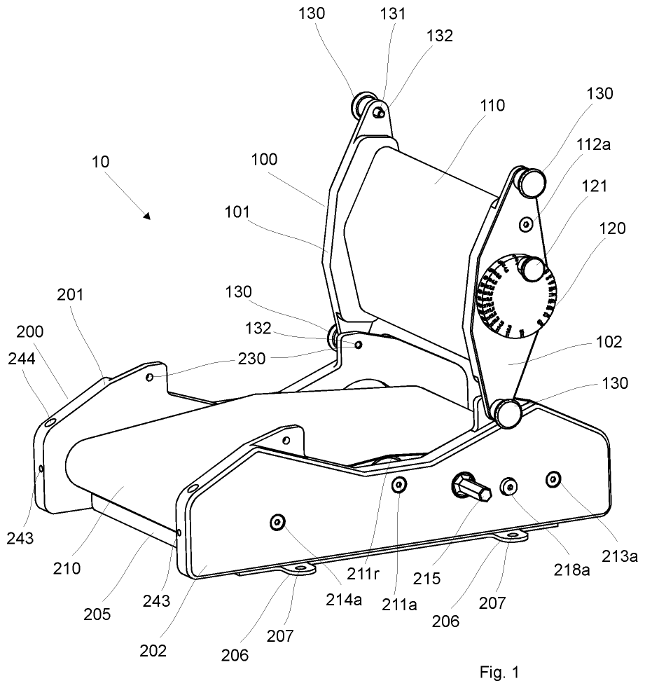

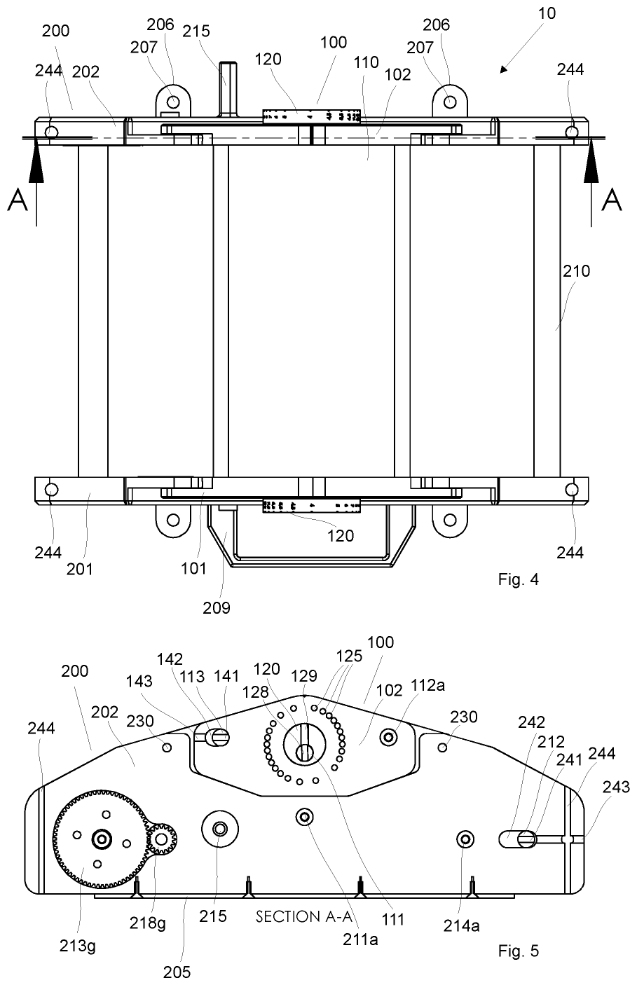

FIGS. 1 to 7 can all be seen as illustrating the same embodiment of the invention or two or more alternative embodiments of the invention.

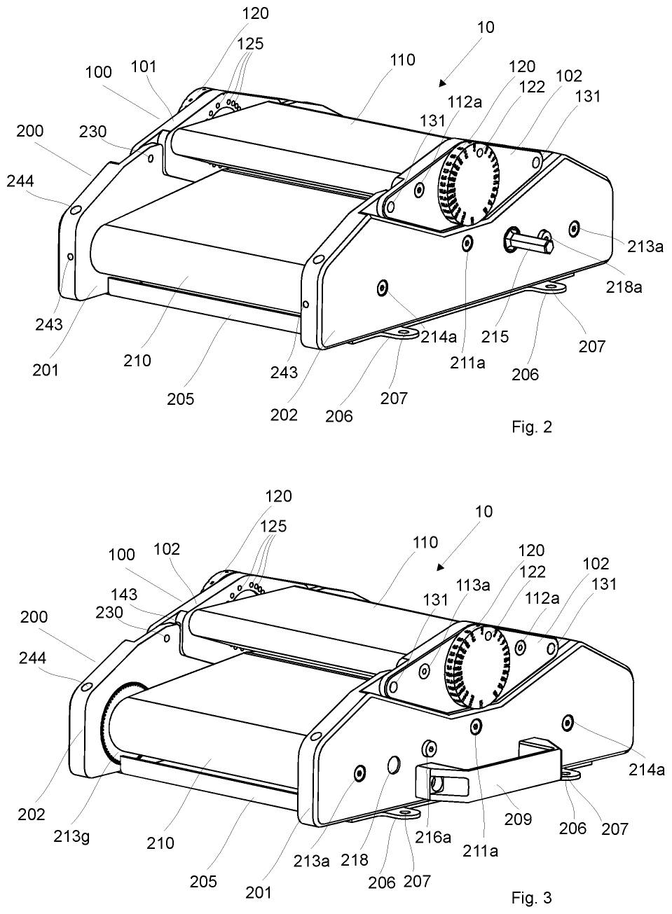

FIG. 1 shows on embodiment of a device 10 that is designed for preparing a liner to be installed in a pipe. In FIG. 1 a top part 100 is in an open position whereas in FIGS. 2 to 7 the top part 100 is in a closed position.

A device 10 for preparing a liner to be installed in a pipe comprises a top part 100 having two or more top rollers 111r, 112r, 113r extending between a first top side 101 and a second top side 102. The device has a top belt 110 arranged on the top rollers 111r, 112r, 113r. The top belt runs around the top rollers like a conveyor belt, moving when any of the top rollers is rotated.

The device further comprises a bottom part 200 having two or more bottom rollers 211r, 212r, 213r extending between a first bottom side 201 and a second bottom side 202. The device has a bottom belt 210 arranged on the bottom rollers 211r, 212r, 213r. At least one of the bottom rollers 211r, 212r, 213r is a pulley roller 213r configured to drive the bottom belt 210 when rotated. The bottom belt runs around the bottom rollers like a conveyor belt, moving when the pulley roller or any other bottom roller is rotated.

For adjusting tightness of the top belt 110, at least one roller of the top rollers 111r, 112r, 113r is movably attached to the first top side 101 and the second top side 102. Similarly, for adjusting tightness of the bottom belt 210, at least one roller of the bottom rollers 211r, 212r, 213r is movably attached to the first bottom side 201 and the second bottom side 202.

Preferably the two or more top rollers 111r, 112r, 113r comprise a main top roller 111r and two auxiliary top rollers 112r, 113r on different sides of the main top roller 111r. One auxiliary top roller 113r is then movably attached to the first top side 101 and the second top side 102 and configured to be movable towards and away from the other auxiliary top roller 112r.

An embodiment of the movable attachment is best shown in FIG. 5. The movably attached auxiliary top roller 113r rotates about a shaft 113 having its ends in slots 142 of the top sides 101, 102. The shaft ends are accessible through cavities 143 extending from periphery of the top sides into the slots 142. The shaft ends have a cavity or a through hole 141 which is preferably threaded. The position of the shaft ends in the slots can be adjusted with e.g. grub screws, set screws or other headless screws through said through hole 141 for moving the shaft 113 and thereby moving said auxiliary top roller 113r. Direction of movement of the auxiliary top roller 113r is horizontal in FIG. 5, i.e. directly towards or away from the other auxiliary top roller 112r.

Preferably two or more bottom rollers 211r, 212r, 213r comprise a main bottom roller 211r, an auxiliary bottom roller 212r and the pulley roller 213r. The auxiliary bottom roller 212r and the pulley roller 213r being located on different sides of the main bottom roller 211r. The auxiliary bottom roller 212r is movably attached to the first bottom side 201 and the second bottom side 202 and configured to be movable towards and away from the pulley roller 213r.

An embodiment of the movable attachment of the auxiliary bottom roller 212r is best shown in FIG. 5. The movably attached auxiliary bottom roller 212r rotates about a shaft 212 having its ends in slots 242 of the bottom sides 201, 202. The shaft ends are accessible through cavities 243 extending from periphery of the bottom sides into the slots 242. The shaft ends have a cavity or a through hole 241 which is preferably threaded. The position of the shaft ends in the slots can be adjusted with e.g. grub screws, set screws or other headless screws through said through hole 241 for moving the shaft 212 and thereby moving said auxiliary bottom roller 212r. Direction of movement of the auxiliary bottom roller 212r is horizontal in FIG. 5, i.e. directly towards or away from the pulley roller 213r. Vertical cavities 244 can be used for attaching a liner support or a funnel to the device 10 for facilitating pouring of epoxy into the liner.

In an embodiment the two or more top rollers 111r, 112r, 113r comprise a main top roller 111r and the two or more bottom rollers 211r, 212r, 213r comprise a main bottom roller 211r. The main top roller 111r, the main bottom roller 211r or both of them are movably attached to the device and are configured to be movable towards each other and away from each other to adjust a gap between the main top roller and the main bottom roller. This gap defines a thickness of a liner prepared with the device.

An embodiment of the movably attached main top roller 111r is best shown in FIGS. 1 and 5. The main top roller 111r is arranged to rotate about a shaft 111 which is eccentrically attached to a rotatable dial 120 of the top part 100, e.g. by having a threaded hole 129 in the dial and a threaded through hole 128 near the end of the shaft 111 and a grub screw, a set screw or other headless screw through said holes 128, 129 locking the shaft to the dial. The gap between the main top roller 111r and the main bottom roller 211r is thereby configured to be adjusted by rotating said dial 120. The adjusting mechanism may have certain predefined gaps configured therein. For example, one or both of the top sides 101, 102 can have cavities or apertures 125 provided therein and a through hole 122 provided on the dial 120. The apertures 125 of the top sides and the through hole 122 of the dial are configured to receive a pin of a knob 121 which locks the position of the dial 120. Removing the knob 121 allows a user to rotate to the dial 120 to adjust the gap which can be locked again by inserting the knob 121.

As described, each of the movably attached auxiliary rollers 113r, 212r rotate about a shaft 113, 212 having its ends in slots 142, 242 of the top sides 101, 102 or the bottom sides 201, 202. The said shaft ends are accessible through cavities 143, 243 for moving the shaft 113, 212 and thereby moving said auxiliary rollers 113r, 212r. This can be achieved e.g. with screws through said holes 141, 241 at the shaft ends for moving the shafts 113, 212 and thereby moving said auxiliary rollers 113r, 212r for tightening the top belt 110 and the bottom belt 210.

For moving the bottom belt 210, the pulley roller 213r of the bottom part 200 is connected to a drive shaft 216 by gears 213g, 218g and the drive shaft 216 is arranged to be rotated through the first bottom side 201 or the second bottom side 202. In addition to the gears 213g, 218g shown in FIGS. 5 and 7, there are also gears on the opposite end of the drive shaft 216 and shaft 218, i.e. on the first bottom side 201. In this embodiment rotation of an input shaft 215 directly rotates the drive shaft 216. A gear at an end of the drive shaft 216, opposite to the input shaft 215 couples to a gear at an end of the shaft 218 thereby coupling the rotation of the input shaft 215 to the shaft 218. The gear 218g on the second bottom side 202 end of the shaft 218 couples to the gear 213g of the pulley shaft 213 fixed to the pulley roller 213r and thus the rotation of the input shaft 215 rotates the pulley roller 213r and thereby moves the bottom belt 210. In an embodiment the shaft 218 could be omitted or replaced with drive shaft 216 and gear of the drive shaft 216 would directly couple to the gear 213g of the pulley shaft 213. The pulley shaft 213 can also be non-rotating and the gear 213g directly attached to the pulley roller 213r. Also other similar arrangements can be used for transferring rotational movement of the input shaft 215 to rotational movement of the pulley roller 213r. Preferably the drive shaft 216 is connected to the input shaft 215 through the first bottom side 201 or the second bottom side 202 and the input shaft is configured to be rotated with a cordless drill or a power drill.

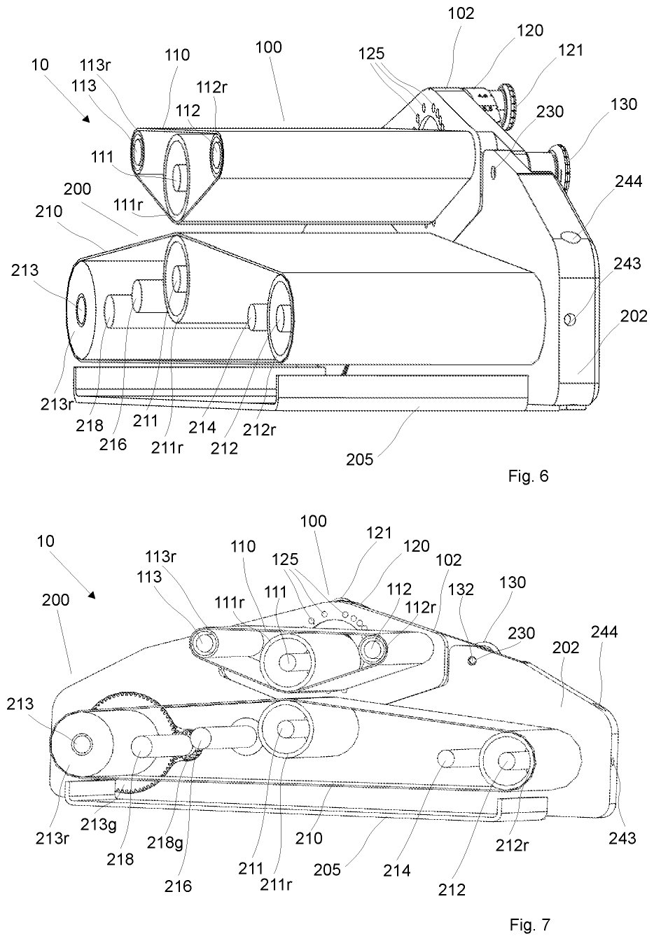

Preferably all rollers of the device 10 rotate about corresponding shaft or with the shaft. Preferably suitable bearings are used between non-rotating shafts and rotating rollers. In the embodiment of FIGS. 6 and 7 for example, the top part 100 has a main top roller 111r rotating about a shaft 111 and two auxiliary top rollers 112r, 113r rotating about shafts 112, 113. Similarly, the bottom part 200 has a main bottom roller 211r rotating about a shaft 211, a pulley roller 213r rotating about a pulley shaft 213 or with the pulley shaft 213, and an auxiliary bottom roller 212r rotating about a shaft 212. In addition, the bottom part has a drive shaft 216 and two other shafts 214, 218 without any rollers. The shafts can be fixed to the bottom sides and top sides by e.g. bolts 211a, 213a, 214a, 216a, 218a, 112a, 113a. The additional shafts 214, 218 increase structural strength of the bottom part together with a base plate 205 extending between and attached to the first and second bottom sides 201, 202. Preferably the base plate also has extensions 206 on the exterior side of the bottom side parts. The extensions have preferably apertures 207 for fixing the device e.g. to a table or a countertop. The device may also have a handle 209 as an extension of the base plate 205 or as a separate entity. The handle 209 is preferably located on an exterior surface of one or both of the bottom sides 201, 202.

In an embodiment the device has a top part 100 that is removably attached to the bottom part 200. Said attachment can be realized by using quick-release mechanisms 130, 131, 132 on the first top side 101 and on the second top side 201. An example of the quick-release mechanism is best shown in FIG. 1 where a knob 130 has a pin 131 extending through an aperture 132 of the first top side 101. These quick-release mechanisms also function as releasable hinges. Similar quick-release mechanism is also on the opposite end of the first top side 101 and on corresponding locations on the second top side 102. The pins 131 of the quick-release mechanism are configured to be inserted in apertures 230 of the first and second bottom sides 201, 202. In FIG. 1, the quick-release mechanism has been released from the left-hand side leaving the right-hand side mechanism to act as a hinge and the top part 100 has been opened into a vertical position. This position already greatly increases the gap between the bottom belt 210 and the top belt 110 and thereby facilitates inserting of a liner to be treated between the belts 110, 210. If the quick-release mechanism on the right-hand side (in FIG. 1) would also be opened, it would allow full removal of the top part 100 from the device 10.

In an embodiment the top part 100 is removably attached to the bottom part 200 using releasable hinges 130, 131, 132, 230 between said top part 100 and the bottom part 200, as seen in e.g. FIG. 1. Preferably said quick-release mechanisms and said releasable hinges comprise apertures 131 on the top part 100, apertures 230 on the bottom part and pins 132. Each pin 132 extends through said aperture 131 on the top part 100 and is configured to be inserted into said aperture 230 on the bottom part 200 and removed from said aperture 230 on the bottom part 200. In a preferred example of this embodiment, the top part 100 comprises four apertures 131, two on the first top side 101 and two on the second top side 102. The apertures 131 are located further away from the main top roller 111r than any of the top rollers 111r, 112r, 113r.

In an embodiment of the device of the present disclosure, the top belt 110, the bottom belt 210 or both the top belt and the bottom belt have an anti-slip coating on the inside surface facing rollers 111r, 112r, 113r, 211r, 212r, 213r, on the outside surface or both the inside surface and the outside surface. The anti-slip coating on the inside surface increases friction between the belts and the rollers which is especially important with the pulley roller 213r which moves the bottom belt 210. On the other hand, the anti-slip coating can also be important on the outside surface where it increases friction between the belts and a liner to be prepared with the device. It is important that the liner moves together with the belt without slipping in order to avoid any damage to the liner. The anti-slip coating can comprise silicone, rubber or polyurethane, or other substances which increase friction between the belts and the rollers or belts and the liner to be prepared.

In an embodiment of the device of the present disclosure, the top belt 110 and the bottom belt 210 can be fully or mainly made out of e.g. polyester, polyamide, silicone, polyurethane or coated fabric. Thickness of the belts is preferably from 0.5 mm to 3 mm, more preferably about 1 mm. The belts can be non-elastic or have some elasticity. Preferably the bottom belt 210 is elastic having effective pull at 1% elongation (k_{1%} relaxed) from 0.02 N/mm width to 0.5 N/mm width, and more preferably from 0.05 N/mm width to 0.15 N/mm width, established in line with ISO 21181:2005. In an embodiment, the top belt 110 is made of PVC and the bottom belt is a belt from Siegling Transilon elastic belt “UU 20U-NA FSTR/FSTR white FDA”, article number 995385.

It is obvious to the skilled person in the art that, as technology develops, the basic idea of the invention can be implemented in various ways. The invention and its embodiments are therefore not limited to only the examples presented above, rather they may vary within the scope of the claims.

I claim:

1. A device for preparing a liner to be installed in a pipe, comprising:
a top part having two or more top rollers extending between a first top side and a second top side and having a top belt arranged on the top rollers,
a bottom part having two or more bottom rollers extending between a first bottom side and a second bottom side and having a bottom belt arranged on the bottom rollers, wherein at least one of the bottom rollers is being a pulley roller configured to drive the bottom belt when rotated,
one roller of the top rollers being movably attached to the first top side and the second top side, and
at least one roller of the bottom rollers being movably attached to the first bottom side and the second bottom side.

2. A device according to claim 1, wherein the two or more top rollers comprise a main top roller and two auxiliary top rollers on different sides of the main top roller, wherein one auxiliary top roller is movably attached to the first top side and the second top side is configured to be movable towards and away from the other auxiliary top roller.

3. A device according to claim 1 wherein the two or more bottom rollers comprise a main bottom roller, an auxiliary bottom roller and the pulley roller, said auxiliary bottom roller and the pulley roller being located on different sides of the main bottom roller, wherein the auxiliary bottom roller is movably attached to the first bottom side and the second bottom side is configured to be movable towards and away from the pulley roller.

4. A device according to claim 1 wherein the two or more top rollers comprise a main top roller, the two or more bottom rollers comprise a main bottom roller, wherein the main top roller, the main bottom roller or both of them are movably attached to the device and are configured to be movable towards each other and away from each other to adjust a gap between the main top roller and the main bottom roller.

5. A device according to claim 4, wherein the main top roller is arranged to rotate about a shaft which is eccentrically attached to a rotatable dial of the top part, wherein the gap between the main top roller and the main bottom roller is configured to be adjusted by rotating said dial.

6. A device according to claim 2 wherein each of the movably attached auxiliary rollers rotate about a shaft having ends in slots of the top sides or the bottom sides, wherein said shaft ends are accessible through cavities for moving the shaft and thereby moving said auxiliary rollers.

7. A device according to claim 1 wherein the pulley roller is connected to a drive shaft by gears and the drive shaft is arranged to be rotated through the first bottom side or the second bottom side.

8. A device according to claim 7, wherein drive shaft is connected to an input shaft through the first bottom side or the second bottom side and the input shaft is configured to be rotated with a cordless drill or a power drill.

9. A device according to claim 1 wherein the top part is removably attached to the bottom part using quick-release mechanisms on the first top side and on the second top side.

10. A device according to claim 1 wherein the top part is removably attached to the bottom part using releasable hinges between said top part and the bottom part.

11. A device according to claim 9 wherein said quick-release mechanisms and said releasable hinges comprise apertures on the top part, apertures on the bottom part and pins, each pin extending through said aperture on the top part and configured to be inserted into said aperture on the bottom part and removed from said aperture on the bottom part.

12. A device according to claim 11, wherein the top part comprises four apertures, two on the first top side and two on the second top side, said apertures being located further away from the main top roller than any of the top rollers.

13. A device according to claim 1 wherein the top belt or the bottom belt has an anti-slip coating on the inside surface facing rollers on the outside surface or both the inside surface and the outside surface.

14. A device according to claim 13, wherein the anti-slip coating comprises silicone, rubber or polyurethane.
